(19) United States
(12) Patent Application Publication
(10) Pub. No.: US 2024/0029088 A1
(43) Pub. Date: Jan. 25, 2024

(54) SYSTEM FOR CUSTOMER CHURN PREDICTION AND PREVENTION

(71) Applicant: ADP, Inc., Roseland, NJ (US)

(72) Inventors: Guilherme GOMES, Porto Alegre (BR); Roberto COUTINHO, Porto Alegre (BR); Carlos NASCIMENTO, Porto Alegre (BR); Roberto SILVEIRA, Porto Alegre (BR)

(73) Assignee: ADP, Inc., Roseland, NJ (US)

(21) Appl. No.: 17/813,444

(22) Filed: Jul. 19, 2022

(51) Int. Cl. G06Q 30/02; G06F 16/901; H04L 67/50

(52) U.S. Cl. CPC G06Q 30/0202; G06Q 30/0281; G06F 16/9027; H04L 67/535

(57) ABSTRACT

A method for predicting customer churn includes receiving a graph data structure storing data associated with activity of a user, the graph data structure having multiple nodes, including a user input node associated with the user. The method includes updating at least the user input node with a vector representation of a received user input, and using historical user input, training a sentiment model to classify user input according to one of multiple sentiments. The method includes using the trained sentiment model to classify the received user input as a particular sentiment, and adding to the graph data structure a sentiment node that is associated with the particular sentiment and that is connected to the user input node. The method includes, using the graph data structure, training a churn model to estimate customer churn probability, and using the trained churned model to estimate a particular churn probability for the user.

### BACKGROUND

### 1. Technical Field

Currently claimed embodiments of the invention relate to an artificial intelligence system, and more specifically, to a system for predicting and preventing customer churn.

### 2. Discussion of Related Art

Customer Churn is the phenomenon where customers of a business no longer purchase or interact with the business. The ability to prevent customer churn is a key factor for success in many types of business. The problem becomes even harder when the service offered is in the form of a mobile application where customers are free to sign up and cancel the service at any time. This is the case for products such as human capital management (HCM) mobile solutions that are designed as an intelligent virtual assistant that requires no human interaction with staff.

Customer churn detection is very important for different types of business for customer retention and understanding of engagement levels. Also, acquiring new clients almost always costs more than retaining existing ones, so every leaving client is an investment loss and also a potential degradation in the net promoter score (NPS). Monitoring churn is the first step in understanding how good the business is at retaining customers and identifying what actions might result in a higher retention rate.

This becomes crucial with online automated services offered to a big number of remote customers. In this scenario, identifying customers at risk of cancelling the service is an even harder task, and taking marketing actions or other classic customer relationship management (CRM) approaches are not feasible or applicable.

Common automated churn detection methods apply classic statistics and data-mining techniques that provide good results but usually are limited to the outcome of informing how likely the customer is to churn. More advanced proposals use techniques to guide specific marketing strategies, which is not an option given the dynamics of a service to many customers that can easily subscribe and cancel without any interaction with staff.

### SUMMARY

According to an embodiment of the invention, a non-transitory computer-readable medium stores a set of instructions for predicting customer churn, which when executed by a computer, configure the computer to receive a graph data structure storing data associated with activity of a user, the graph data structure including multiple nodes that include a user input node associated with the user. The instructions further configure the computer to update at least the user input node with a vector representation of a received user input, and, using historical user input, train a sentiment model to classify user input according to one of multiple sentiments. The instructions further configure the computer to use the trained sentiment model to classify the received user input as a particular sentiment from multiple sentiments, add to the graph data structure a sentiment node that is associated with the particular sentiment and that is connected to the user input node, and, using the graph data structure, train a churn model to estimate user churn probability. The instructions further configure the computer to use the trained churn model to estimate a particular churn probability for the user.

According to an embodiment of the invention, a non-transitory computer-readable medium stores a set of instructions for preventing customer churn, which when executed by a computer, configure the computer to, for a particular customer, receive a probability that the particular customer is likely to churn, and use multiple user retentions to update a reinforcement model for selecting retention actions for customers. The instructions further configure the computer to, based on a determination that the particular customer is likely to churn, use the updated reinforcement model to select a particular retention action from multiple retention actions, and implement the particular retention action for the particular customer.

According to an embodiment of the invention, a method for predicting customer churn includes receiving a graph data structure storing data associated with activity of a user, the graph data structure including multiple nodes that include a user input node associated with the user. The method further includes updating at least the user input node with a vector representation of a received user input, and, using historical user input, training a sentiment model to classify user input according to one of multiple sentiments. The method further includes using the trained sentiment model to classify the received user input as a particular sentiment from the plurality of sentiments, adding to the graph data structure a sentiment node that is associated with the particular sentiment and that is connected to the user input node, and, using the graph data structure, training a churn model to estimate customer churn probability. The method further includes using the trained churned model to estimate a particular churn probability for the user.

According to an embodiment of the invention, a method for preventing customer churn includes, for a particular customer, receiving a probability that the particular customer is likely to churn, and, using multiple user retentions, updating a reinforcement model for selecting retention actions for customers. The method further includes, based on a determination that the particular customer is likely to churn, using the updated reinforcement model to select a particular retention action from multiple retention actions, and implementing the particular retention action for the particular customer.

### BRIEF DESCRIPTION OF THE DRAWINGS

Further objectives and advantages will become apparent from a consideration of the description, drawings, and examples.

FIG. 1 shows a human capital management (HCM) mobile solution designed as an intelligent virtual assistant interface.

FIG. 2 conceptually illustrates a neural network used by the HCM system in some embodiments.

FIG. 3 shows a churn probability estimation process performed by the HCM system of some embodiments.

FIG. 4 shows a conceptual example of an extract, transform, and load (ETL) process of some embodiments.

FIG. 5 shows an example of a visualization of a graph data structure modeling the activity of a user associated with a customer.

FIG. 6 shows an example of generating semantic and contextual representations of chat messages.

FIG. 7 shows an example of a sentiment classifier that is composed of two artificial neural networks.

FIG. 8 shows an example of an ensemble sentiment classifier with prediction and uncertainty outputs, made up of multiple sentiment classifiers as shown in FIG. 7.

FIG. 9 shows an updated version of the visualization of the graph data structure after updating the graph data structure with the result of the sentiment classification.

FIG. 10 shows an example of how learned vector representations are added as new features to nodes in the graph model.

FIG. 11 illustrates churn probability estimation in some embodiments for one node in the graph model.

FIG. 12 shows an updated version of the visualization of the graph data structure after updating the graph data structure with previous churns.

FIG. 13 shows a customer retention process performed by the HCM system of some embodiments.

FIG. 14 shows a customer retention action problem modeled as a Multi-Armed Bandit (MAB) problem.

FIG. 15 conceptually illustrates an example of an architecture of an electronic device with which some embodiments of the invention are implemented.

FIG. 16 conceptually illustrates an electronic system with which some embodiments of the invention are implemented.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed, and other methods developed, without departing from the broad concepts of the current invention. All references cited anywhere in this specification, including the Background and Detailed Description sections, are incorporated by reference as if each had been individually incorporated.

Some embodiments describe a system and method to address the customer churn prediction problem by monitoring customers, predicting potential churns with accuracy, and automatically acting to prevent these churns. Some embodiments apply Artificial Intelligence (AI) or machine-learning (ML) techniques to automatically and dynamically monitor the activity of users of a business's application, detect customers at potential risk to cancel the subscription of the product, and proactively explore and learn the best actions to prevent losing those customers. These actions may be automatically applied or suggested as insights for the business.

Some embodiments provide a fully automated solution that predicts churns using graph neural networks, and also learns the best prevention strategy that is automatically applied and evaluated via reinforcement learning techniques.

In some embodiments, the churn prediction uses application data that has been transformed into graph data structures, so that multiple techniques of Machine Learning for Graphs may be applied. These techniques are capable of learning multiple aspects of the relationships revealed by the graph structures, and are able to propagate this information to perform the predictions. The learned aspects of the graph structures are also captured to provide a diversity of insights, such as application domains usage and functionalities more associated with activity of unsatisfied customers.

Some embodiments also explore and learn the best actions to be taken in order to prevent the predicted churns (referred to as customer retention). Some embodiments model the problem as a Multi-Armed Bandit (MAB) problem and treat it using reinforcement learning techniques.

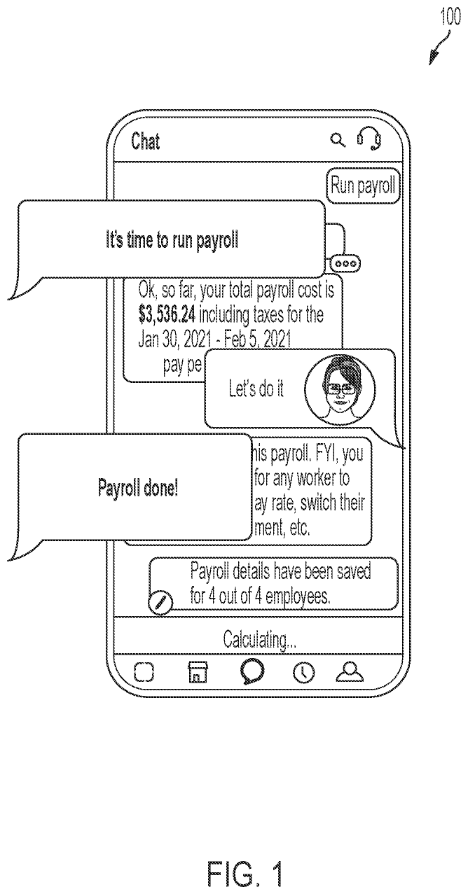

Some embodiments provide a human capital management (HCM) system as a mobile solution, designed as an intelligent virtual assistant interface 100 where customers can do tasks like run payroll, hire employees and tax filing just like sending a chat message, as shown in FIG. 1. Using artificial intelligence techniques for Natural Language Processing (NLP), the HCM system identifies the intent of the message, any eventual entities (persons, dates, places or documents) that it may contain and starts a conversation. A conversation is a structured sequence of questions and forms presented in the chat interface 100 that guides the user on correctly filling all the required information to complete the desired operation, e.g., “Run Payroll.”

The HCM system of some embodiments offers hundreds of intents that are therefore mapped to conversations. Each of these conversations can have multiple flows and end up in different actions depending on the answers. Some embodiments use Graph Neural Networks (GNN) or Graph Convolution Networks (GCN) to analyze this diversity of ways and how different users interact with the assistant, predict customers with high risk of churn and, given a set of possible actions to prevent the churns, explore, learn the most effective one, and then exploit it.

The neural network of some embodiments is a multi-layer machine-trained network (e.g., a feed-forward neural network). Neural networks, also referred to as machine-trained networks, will be herein described. One class of machine-trained networks are deep neural networks with multiple layers of nodes. Different types of such networks include feed-forward networks, convolutional networks, recurrent networks, regulatory feedback networks, radial basis function networks, long-short term memory (LSTM) networks, and Neural Turing Machines (NTM). Multi-layer networks are trained to execute a specific purpose, including face recognition or other image analysis, voice recognition or other audio analysis, large-scale data analysis (e.g., for climate data), etc. In some embodiments, such a multi-layer network is designed to execute on a mobile device (e.g., a smartphone or tablet), an IOT device, a web browser window, etc.

A typical neural network operates in layers, each layer having multiple nodes. In convolutional neural networks (a type of feed-forward network), a majority of the layers include computation nodes with a (typically) nonlinear activation function, applied to the dot product of the input values (either the initial inputs based on the input data for the first layer, or outputs of the previous layer for subsequent layers) and predetermined (i.e., trained) weight values, along with bias (addition) and scale (multiplication) terms, which may also be predetermined based on training. Other types of neural network computation nodes and/or layers do not use dot products, such as pooling layers that are used to reduce the dimensions of the data for computational efficiency and speed.

For convolutional neural networks that are often used to process electronic image and/or video data, the input activation values for each layer (or at least each convolutional layer) are conceptually represented as a three-dimensional array. This three-dimensional array is structured as numerous two-dimensional grids. For instance, the initial input for an image is a set of three two-dimensional pixel grids (e.g., a 1280×720 RGB image will have three 1280×720 input grids, one for each of the red, green, and blue channels). The number of input grids for each subsequent layer after the input layer is determined by the number of subsets of weights, called filters, used in the previous layer (assuming standard convolutional layers). The size of the grids for the subsequent layer depends on the number of computation nodes in the previous layer, which is based on the size of the filters, and how those filters are convolved over the previous layer input activations. For a typical convolutional layer, each filter is a small kernel of weights (often 3×3 or 5×5) with a depth equal to the number of grids of the layer's input activations. The dot product for each computation node of the layer multiplies the weights of a filter by a subset of the coordinates of the input activation values. For example, the input activations for a 3×3×Z filter are the activation values located at the same 3×3 square of all Z input activation grids for a layer.

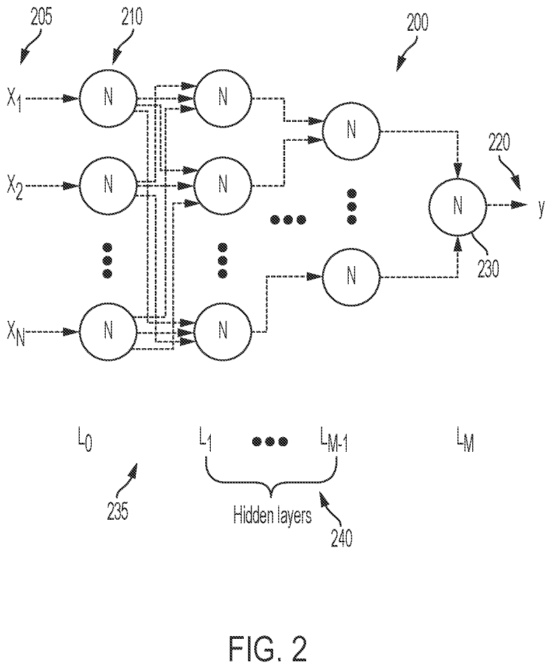

FIG. 2 illustrates an example of a multi-layer machine-trained network used by the HCM system in some embodiments. This figure illustrates a feed-forward neural network 200 that receives an input vector 205 (denoted x₁, x₂, . . . x_{N}) at multiple input nodes 210 and computes an output 220 (denoted by y) at an output node 230. The neural network 200 has multiple layers L₀, L₁, L₂ . . . L_{M} 235 of processing nodes (also called neurons, each denoted by N). In all but the first layer (input, L₀) and last layer (output, L_{M}), each node receives two or more outputs of nodes from earlier processing node layers and provides its output to one or more nodes in subsequent layers. These layers are also referred to as the hidden layers 240. Though only a few nodes are shown in FIG. 2 per layer, a typical neural network may include a large number of nodes per layer (e.g., several hundred or several thousand nodes) and significantly more layers than shown (e.g., several dozen layers). The output node 230 in the last layer computes the output 220 of the neural network 200.

In this example, the neural network 200 only has one output node 230 that provides a single output 220. Other neural networks of other embodiments have multiple output nodes in the output layer L_{M} that provide more than one output value. In different embodiments, the output 220 of the network is a scalar in a range of values (e.g., 0 to 1), a vector representing a point in an N-dimensional space (e.g., a 128-dimensional vector), or a value representing one of a predefined set of categories (e.g., for a network that classifies each input into one of eight possible outputs, the output could be a three-bit value).

Portions of the illustrated neural network 200 are fully-connected in which each node in a particular layer receives as inputs all of the outputs from the previous layer. For example, all the outputs of layer L₀ are shown to be an input to every node in layer L₁. The neural networks of some embodiments are convolutional feed-forward neural networks, where the intermediate layers (referred to as “hidden” layers) may include other types of layers than fully-connected layers, including convolutional layers, pooling layers, and normalization layers.

The convolutional layers of some embodiments use a small kernel (e.g., 3×3×3) to process each tile of pixels in an image with the same set of parameters. The kernels (also referred to as filters) are three-dimensional, and multiple kernels are used to process each group of input values in a layer (resulting in a three-dimensional output). Pooling layers combine the outputs of clusters of nodes from one layer into a single node at the next layer, as part of the process of reducing an image (which may have a large number of pixels) or other input item down to a single output (e.g., a vector output). In some embodiments, pooling layers can use max pooling (in which the maximum value among the clusters of node outputs is selected) or average pooling (in which the clusters of node outputs are averaged).

Each node computes a dot product of a vector of weight coefficients and a vector of output values of prior nodes (or the inputs, if the node is in the input layer), plus an offset. In other words, a hidden or output node computes a weighted sum of its inputs (which are outputs of the previous layer of nodes) plus an offset (also referred to as a bias). Each node then computes an output value using a function, with the weighted sum as the input to that function. This function is commonly referred to as the activation function, and the outputs of the node (which are then used as inputs to the next layer of nodes) are referred to as activations.

Consider a neural network with one or more hidden layers 240 (i.e., layers that are not the input layer or the output layer). The index variable l can be any of the hidden layers of the network (i.e., l∈{1, . . . M−1}, with l=0 representing the input layer and l=M representing the output layer).

The output yₗ₊₁ of node in hidden layer l+1 can be expressed as:

yₗ₊₁ƒ((wₗ₊₁·yₗ)*c+bₗ₊₁) (1)

This equation describes a function, whose input is the dot product of a vector of weight values wₗ₊₁ and a vector of outputs yₗ from layer l, which is then multiplied by a constant value c, and offset by a bias value bₗ₊₁. The constant value c is a value to which all the weight values are normalized. In some embodiments, the constant value c is 1. The symbol * is an element-wise product, while the symbol is the dot product. The weight coefficients and bias are parameters that are adjusted during the network's training in order to configure the network to solve a particular problem (e.g., object or face recognition in images, voice analysis in audio, depth analysis in images, etc.).

In equation (1), the function ƒ is the activation function for the node. Examples of such activation functions include a sigmoid function (ƒ(x)=1/(1+e^{-x})), a tan h function, or a ReLU (rectified linear unit) function (ƒ(x)=max(0,x)). See Nair, Vinod and Hinton, Geoffrey E., “Rectified linear units improve restricted Boltzmann machines,” ICML, pp. 807-814, 2010, incorporated herein by reference in its entirety. In addition, the “leaky” ReLU function (f(x)=max(0.01*x, x)) has also been proposed, which replaces the flat section (i.e., x<0) of the ReLU function with a section that has a slight slope, usually 0.01, though the actual slope is trainable in some embodiments. See He, Kaiming, Zhang, Xiangyu, Ren, Shaoqing, and Sun, Jian, “Delving deep into rectifiers: Surpassing human-level performance on imagenet classification,” arXiv preprint arXiv:1502.01852, 2015, incorporated herein by reference in its entirety. In some embodiments, the activation functions can be other types of functions, including gaussian functions and periodic functions.

Before a multi-layer network can be used to solve a particular problem, the network is put through a supervised training process that adjusts the network's configurable parameters (e.g., the weight coefficients, and additionally in some cases the bias factor). The training process iteratively selects different input value sets with known output value sets. For each selected input value set, the training process typically (1) forward propagates the input value set through the network's nodes to produce a computed output value set and then (2) back-propagates a gradient (rate of change) of a loss function (output error) that quantifies the difference between the input set's known output value set and the input set's computed output value set, in order to adjust the network's configurable parameters (e.g., the weight values).

In some embodiments, training the neural network involves defining a loss function (also called a cost function) for the network that measures the error (i.e., loss) of the actual output of the network for a particular input compared to a pre-defined expected (or ground truth) output for that particular input. During one training iteration (also referred to as a training epoch), a training dataset is first forward-propagated through the network nodes to compute the actual network output for each input in the data set. Then, the loss function is back-propagated through the network to adjust the weight values in order to minimize the error (e.g., using first-order partial derivatives of the loss function with respect to the weights and biases, referred to as the gradients of the loss function). The accuracy of these trained values is then tested using a validation dataset (which is distinct from the training dataset) that is forward propagated through the modified network, to see how well the training performed. If the trained network does not perform well (e.g., have error less than a predetermined threshold), then the network is trained again using the training dataset. This cyclical optimization method for minimizing the output loss function, iteratively repeated over multiple epochs, is referred to as stochastic gradient descent (SGD).

In some embodiments the neural network is a deep aggregation network, which is a stateless network that uses spatial residual connections to propagate information across different spatial feature scales. Information from different feature scales can branch-off and re-merge into the network in sophisticated patterns, so that computational capacity is better balanced across different feature scales. Also, the network can learn an aggregation function to merge (or bypass) the information instead of using a non-learnable (or sometimes a shallow learnable) operation found in current networks.

Deep aggregation networks include aggregation nodes, which in some embodiments are groups of trainable layers that combine information from different feature maps and pass it forward through the network, skipping over backbone nodes. Aggregation node designs include, but are not limited to, channel-wise concatenation followed by convolution (e.g., DispNet), and element-wise addition followed by convolution (e.g., ResNet). See Mayer, Nikolaus, Ilg, Eddy, Musser, Philip, Fischer, Philipp, Cremers, Daniel, Dosovitskiy, Alexey, and Brox, Thomas, “A Large Dataset to Train Convolutional Networks for Disparity, Optical Flow, and Scene Flow Estimation,” arXiv preprint arXiv:1512.02134, 2015, incorporated herein by reference in its entirety. See He, Kaiming, Zhang, Xiangyu, Ren, Shaoqing, and Sun, Jian, “Deep Residual Learning for Image Recognition,” arXiv preprint arXiv: 1512.03385, 2015, incorporated herein by reference in its entirety.

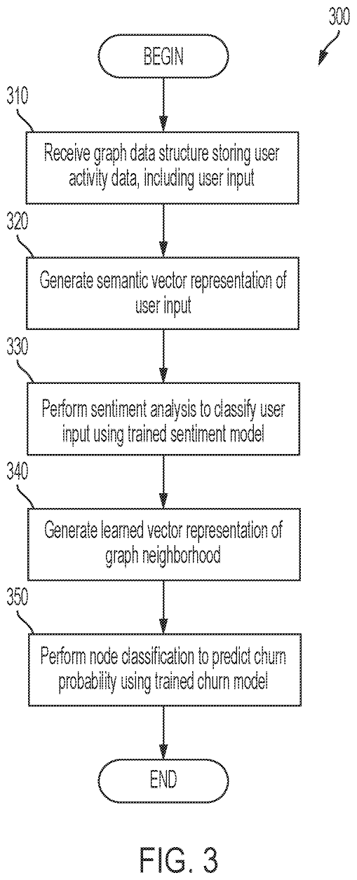

FIG. 3 shows a churn probability estimation process 300 performed by the HCM system of some embodiments. At 310, the process 300 begins by receiving a graph data structure that stores data associated with activity of a user. The graph data structure has multiple nodes, including a user input node associated with the user that stores input received from the user (e.g., text input received from the user through the chat interface 100). Examples of user input nodes include chat nodes, user feedback nodes, and conversation nodes.

In some embodiments, the graph data structure stores data for one or more users who are associated with a customer, and the graph also includes a customer node that is associated with (e.g., connected to) the corresponding user input nodes for each user associated with the customer. Each user may also have a user node connected to the corresponding user input node and the associated customer node.

In some embodiments, the graph data structure stores activity data for multiple customers, each with multiple associated users, and has corresponding nodes for the customers, their users, and the users' data input. Some customers may have churned, and the graph data structure may assign a label indicating the churned status (e.g., a “canceled” label) to such customers, or have at least one additional node to indicate the churned status (e.g., a “canceled” node) that is connected to the churned customers.

In some embodiments, the graph data structure is generated by an extract, transform, load process, by extracting data from a relational database that stores a system of records associated with the activity of the user, transforming the extracted data to a database format that natively supports graph data structures, and loading the transformed data into the graph data structure.

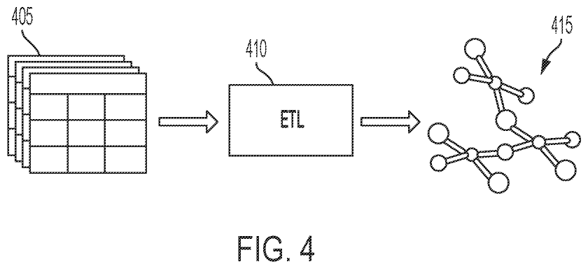

FIG. 4 shows a conceptual example of an extract, transform, and load (ETL) process of some embodiments. In this example, the information of customer's activity is primarily captured by the main application system of records (SOR) 405. The SOR 405 in some embodiments is a relational SQL database, but SOR's based in other types of database solutions could be used in other embodiments.

An ETL process 410 periodically reads the SOR 405 data, transforms it into the target graph data model, and loads into a database that supports a graph model 415. Neo4J (Neo4j, Inc., San Mateo CA) and Amazon Neptune (Amazon.com, Inc., Seattle WA) are examples of graph database technologies that can be applied to persist the data natively in graph structures.

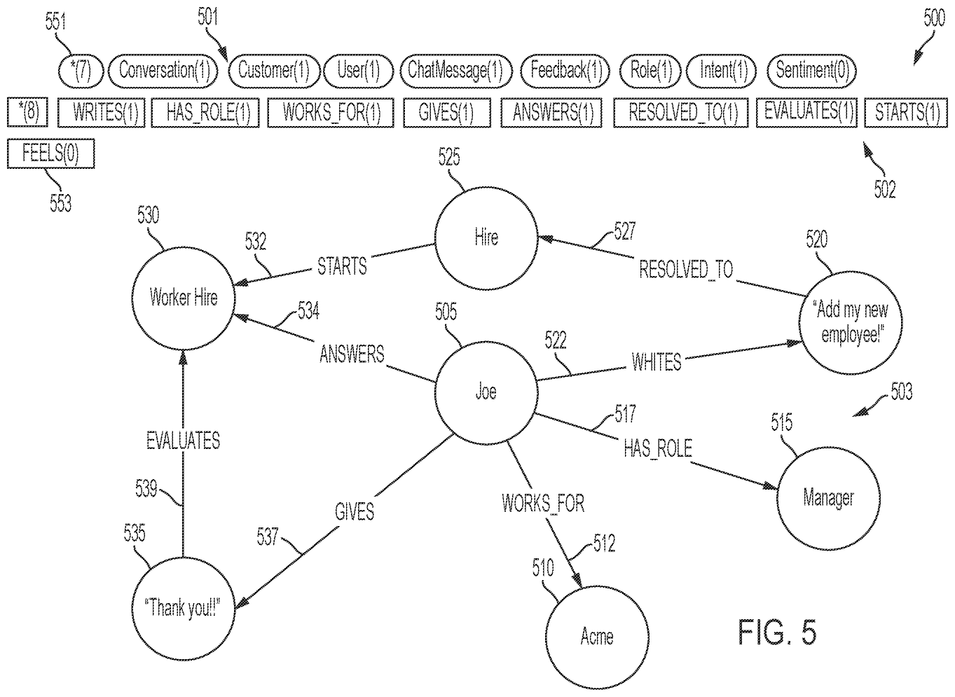

The graph data structure resulting from an ETL process such as the example in FIG. 4 is modeled to favor the traversing of the relationships required to solve the churn detection problem. FIG. 5 shows an example of a visualization 500 of a graph data structure modeling the activity of a user associated with a customer. In this example, the user works for “Acme” customer company. The visualization 500 of the graph data structure has multiple nodes representing different entities, including but not limited to users (e.g., employees), user roles, customers (e.g., customers), chat messages from users, user feedback, conversations between the user and the system, user intent, and sentiment. In addition, the graph data structure has multiple edges connecting the nodes to each other, to indicate various relationships, including but not limited to WRITES to indicate a user is the author of a message, GIVES to indicate a user is giving a particular feedback, ANSWERS to indicate a user is answering questions in a conversation, WORKS_FOR to indicate a user is an employee of a customer, HAS_ROLE to indicate the role of the user for the customer, RESOLVED_TO to indicate that a chat message has been resolved to an intent, STARTS to indicate that an event has initiated a conversation, EVALUATES to indicate that a particular feedback is being used to evaluate a conversation, and FEELS to indicate that a particular feedback has been classified according to a particular sentiment.

The visualization 500 of the graph data structure may be displayed as a graphical user interface (GUI) on a display in some embodiments. In this case, the GUI allows the user to directly create, read, update, and delete the nodes and edges in the graph data structure, by interacting (e.g., with a mouse, keyboard, and/or touchscreen) with different GUI elements and menus. For example, the GUI may include a menu 501 that lists the different types of nodes as well as listing the current total number of nodes and the current number of nodes of each type. The GUI may also include an edge menu 502 that lists the different types of edges as well as the current total number of edges and the current number of edges of each type. The GUI may also include a graph 503 that graphically depicts the nodes and edges for ease of visualization and interaction. In some embodiments, the GUI may also use coding to indicate different types and properties of the nodes and/or edges, such as (but not limited to) node shape, color, edge type (e.g., solid, dashed, dotted, etc.), edge weight (thickness), and node size.

In the example of FIG. 5, Joe is an employee and a manager of the Acme company. Accordingly, in the graph data structure, Joe is represented by a user node 505, the Acme company is represented by a customer node 510, and the two are connected by an edge 512 to indicate a WORKS_FOR relationship, since Joe works for Acme. Joe's role as a manager is represented by a role node 515 of type “Manager”, which is connected to the user node 505 by an edge 517 to indicate a HAS_ROLE relationship.

Joe wants to hire a new employee, so initiates this action by writing an “Add my new employee” message, e.g., by speaking or typing into the interface 100 of the intelligent virtual assistant. In the graph data structure, the chat message is represented by a chat message node 520, which is connected to the user node 505 by an edge 522 to indicate a WRITES relationship, since Joe wrote the chat message.

The chat message is processed by an ensemble of Natural Language Processing Machine Learning models that identify and resolve the chat message to a HIRE intent. The HIRE intent is represented by an intent node 525, which is connected to the chat message node 520 by an edge 527 to indicate a RESOLVED_TO relationship.

The HIRE intent starts a “Worker Hire” chat conversation, that is represented in the graph data structure by a conversation node 530. The conversation node 530 is connected to the intent node 525 by an edge 532 that indicates a STARTS relationship. Through the conversation, the intelligent virtual assistant asks questions to Joe (through the interface 100) in order to get all the information necessary to complete the hiring process (e.g., new employee name, tax information, contact information, salary, role, etc.). The user node 505 is connected to the conversation node 530 by an edge 534 that indicates an ANSWERS relationship. At the end of the conversation, the user is asked to provide feedback about how satisfied they were with the process. The feedback is represented by a feedback node 535, that is connected to the user node 505 by an edge 537 that indicates a GIVES relationship.

In some embodiments, the feedback is applied to reinforcement learning techniques that will be discussed in more detail below, and may also used to evaluate the conversation process, which can be improved based on user suggestions. For example, in the graph data structure, the feedback node 535 is connected to the conversation node 530 by an edge 539 that indicates an EVALUATES relationship.

In the example visualization 500 of FIG. 5, the menu 501 has an indicator 551 that indicates that there are currently seven total nodes in the graph data structure. The menu 501 also has individual indicators for each node type, which can be color coded to match the colors in the graph 503. Likewise, the edge menu 502 also has an indicator 553 that indicates that there are currently eight total edges in the graph data structure. Note that at this stage of the process 300, there are no sentiment nodes or FEELS relationships in the graph data structure, as yet.

Returning to FIG. 3, the process 300 generates at 320 a contextual, semantic vector representation of the received user input. The semantic vector representation of the user input is used to update the graph data structure. For example, the semantic vector representation may be used to update the user node 505, and/or the customer node 510. In some embodiments, the process 300 uses natural language processing models to generate the semantic vector representation.

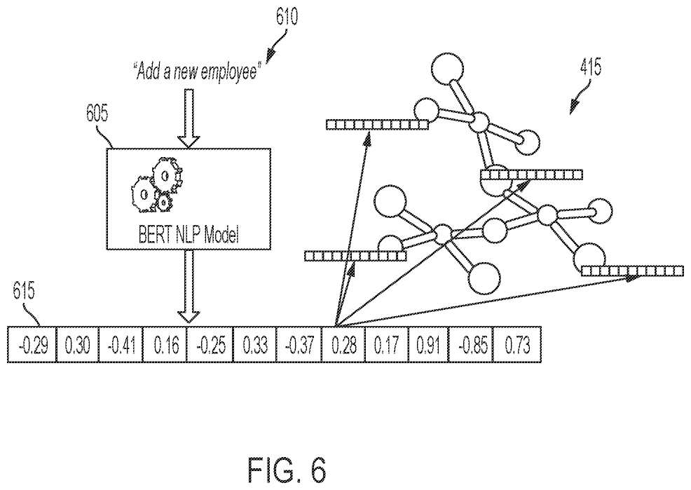

FIG. 6 shows an example of generating semantic and contextual representations of chat messages. Once the relational tabular data from the SOR 405 is transformed into the graph model 415, language processing models 605 based on Transformers and self-attention mechanisms can be applied to generate the semantic and contextual representations. Chat messages 610 are encoded as semantic vector representations 615 that are added to the nodes of the graph model 415 as properties of the nodes. For the models 605, some embodiments use BERT, a Transformer-based language model [1] to encode the chat messages 610. In other embodiments, other options of representations like GloVe [2] and ELMo [3] are applicable.

The generated semantic vector representations 615 (also known as embeddings) are added as features to those nodes in the graph model 415 that represent the text messages 610. This information can be used in many NLP tasks like text classification and semantic analysis, which are required for the sentiment classification operation that is performed in some embodiments as described in further detail with reference below to operation 330 of process 300.

Returning to FIG. 3, the process 300 performs at 330 a sentiment classification on the representation of the user input, using a trained sentiment model, to classify the user input as one of several different sentiments. For example, the sentiments may include a negative sentiment, a positive sentiment, and a neutral sentiment. In some embodiments, a sentiment node is added to the graph data structure, and connected to the user input node.

The sentiment model is trained in some embodiments using historical user input. For example, the sentiment model may be multiple convolution neural networks, arranged in parallel and trained in parallel using the historical user input.

For example, in some embodiments, to perform such classification task, an ensemble of bootstrapped deep learning models is adopted to classify the sentiment along with uncertainty estimation. The uncertainty estimation is based on the entropy of the predictions of each member of the ensemble and is important to prevent models' misbehavior when facing chat messages out of the training distribution. As an example, if the model is trained on a distribution of words from the HCM domain, its outcomes for text messages about physics are potentially unpredictable. The ensemble approach returns high uncertainty for these cases, so special actions can be taken, like discarding the prediction.

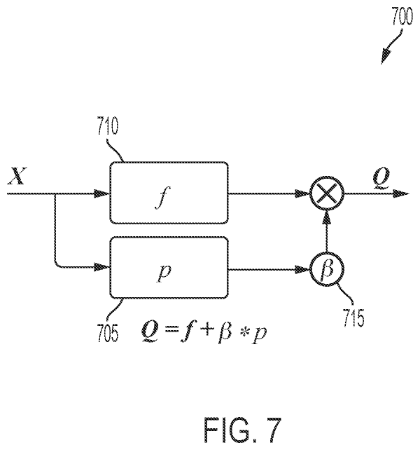

FIG. 7 shows an example of an ensemble member 700 that is composed of two artificial neural networks (ANN), p 705 and ƒ 710. Both networks are fed the same input X 712, and the outputs of the networks p 705 and ƒ 710 are summed to produce a combined output Q 714, with a scaling factor β 715. The function p 705 is a prior function that is randomly initialized among different ensemble members, and is not updated during the training process. The function ƒ 710 is the network that gets trained and learns how to classify the sentiment. scaling factor β 715 is trainable in some embodiments.

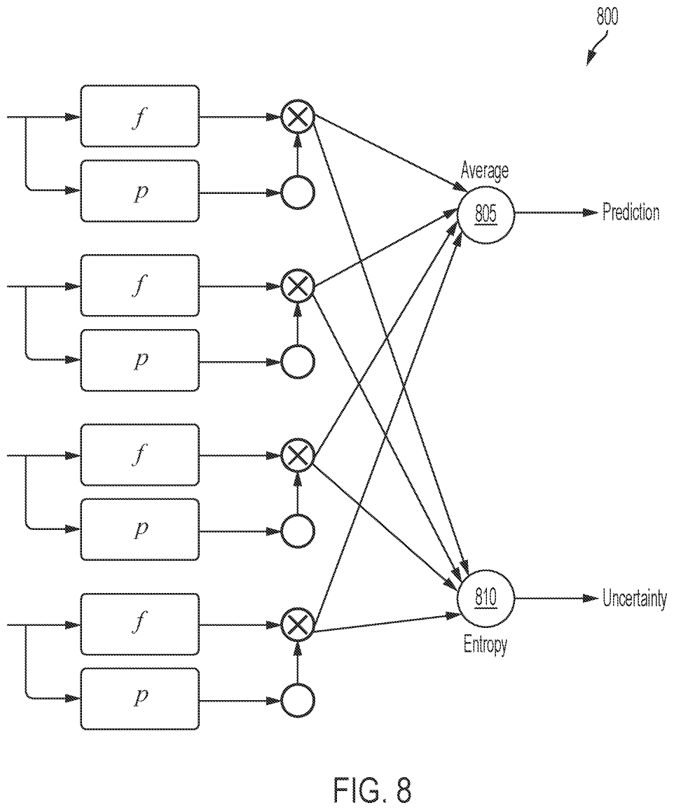

FIG. 8 shows an example of an ensemble model 800 with prediction and uncertainty outputs, that is used in some embodiments to classify the user input (e.g., chat messages and feedback) into one of the sentiments. The ensemble model 800 is made up of multiple individual members 700 such as the one shown in FIG. 7. From a dataset of historical text messages labeled as Positive, Negative and Neutral, one different sample is drawn for each model of the ensemble model 800 to run the training process. By perturbing the training data in that way, trained models are produced, representing samples of the learned posterior distribution. From these trained ensembles, the final classification is obtained based on the average 805 of each individual classification, and the uncertainty 810 of the final classification is estimated from the entropy of these same classifications.

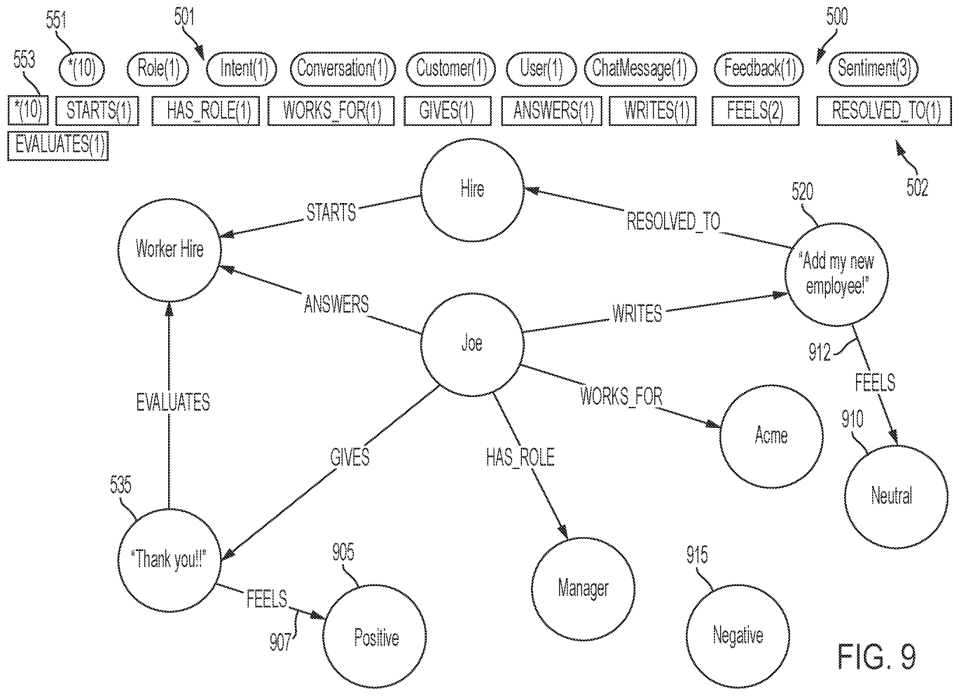

This process is applied to text messages entered by the users and the information of resulting classifications is added to the graph as new nodes representing the sentiment. FIG. 9 shows an updated visualization 900 of the graph data structure after updating the graph data structure with the result of the sentiment classification. In FIG. 9, like reference numerals have been used to refer to the same or similar components as in FIG. 5. A detailed description of some such components will be omitted, and the following discussion focuses on the differences between these embodiments.

After updating the graph data structure with sentiment classification, the user feedback from Joe is associated with the “positive” sentiment. The positive sentiment is represented in the graph data structure by a positive sentiment node 905, that is connected to feedback node 535 by an edge 907 that indicates a FEELS relationship. Also, the text message is associated with the “neutral” sentiment. The neutral sentiment is represented by a neutral sentiment node 910, that is connected to the chat message node 520 by an edge 912 that indicates a FEELS relationship. In addition, the graph data structure may also have a negative sentiment node 915. In this example, none of the inputs have been classified by the ensemble model 800 as having a negative sentiment, so there are no edges connecting the negative sentiment node 915 to any other node.

In some embodiments, the indicator 551 of the menu 501 is also updated to indicate that there are now ten total nodes in the graph data structure. This is because three new sentiment nodes (nodes 905, 910, 915) were added after sentiment classification of the chat message and the user feedback. Likewise, the indicator 553 of the edge menu 502 also has been updated to indicate that there are now ten total edges in the graph data structure. This is to indicate the two new FEELS relationships (edges 907, 912), between the positive sentiment node 905 and the user feedback node 535, and between the neutral sentiment node 910 and the chat message node 520. In other embodiments, the visualization is not updated.

In some embodiments, only a single sentiment node for each possible sentiment is present in the graph data structure, with edge connections to all relevant nodes that have been classified according to that sentiment (if any). In that case, the total number of sentiment nodes would be constant and equal to the number of possible sentiments (e.g., three, when the sentiments are positive, neutral, and negative). In other embodiments, each node that has been classified according to a sentiment is connected to a separate sentiment node of the appropriate type. In that case, the total number of sentiment nodes would be equal to the total number of nodes that have been classified by sentiment. In still other embodiments, no sentiment nodes may be added to the graph data structure, and instead the sentiment to which the user input was classified is added to the corresponding node as a metadata update, analogous to updating the node with the vector representation in operation 320 of process 300.

Returning to FIG. 3, the process 300 generates at 340 a learned vector representation of the neighborhood of the nodes within the graph data structure that are associated with the user input (e.g., the user node 505, the chat message node 520, the feedback node 535, the customer node 510, etc.). The learned vector representation is used to update the graph data structure, by updating one or more of the user input nodes. The learned vector representation of the neighborhood may include connections of the user input nodes to other nodes, and types of nodes connected to the user input nodes. The learned vector representation of the neighborhood of the graph data structure is generated in some embodiments by using a second-order random walk technique.

In some embodiments, the nodes and edges of the graph data structure are mapped to dense vector representations, analogous to the semantic vector representations generated in operation 320 of process 300. The difference is that instead of learning language representations of text messages, here the learned vector representations describe many aspects of the resulting graph structures, such as community structures and roles of nodes. This latent information carried by these learned vector representations can be used in many downstream graph analytics tasks, such as graph visualization, node classification, link prediction, and graph clustering. In the context of churn prediction, node classification and link prediction are tasks that help solve the problem.

In some embodiments, a second-order random walk technique named Node2Vec [4] is adopted because of its capability to preserve structural equivalence and explore nodes' neighborhoods with higher orders of proximity. In other embodiments, other representation learning techniques can be adopted, like Structural Deep Network Embedding (SDNE) [5] and Higher-Order Proximity preserved Embedding (HOPE) [6] which are also being experimented.

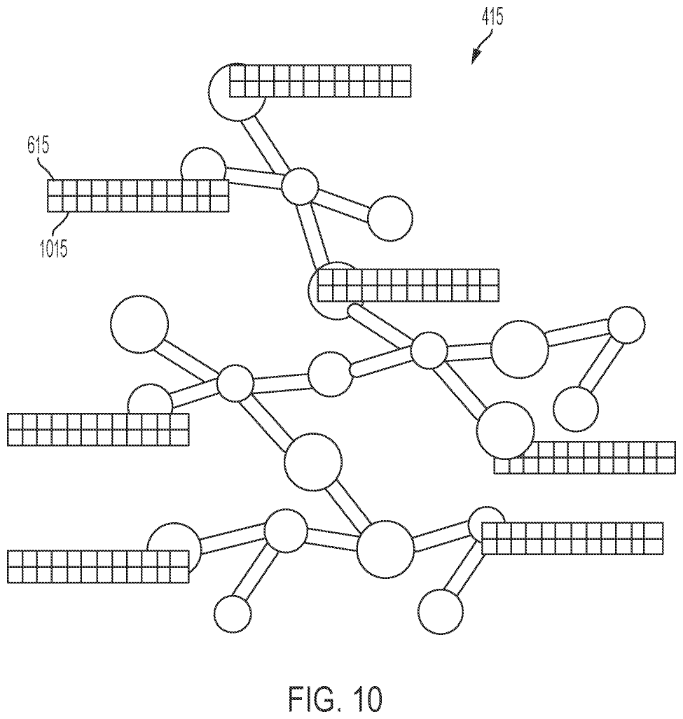

FIG. 10 shows an example of how learned vector representations are added as new features to nodes in the graph model 415. In this example, the semantic (language) vector representations 615 and the learned (graph) vector representations 1015 are shown with the same length, i.e. the same number of dimensions, but this is a parametrization that can be modified (e.g., the latent representation size). Some embodiments apply the Node2Vec method in order to realize certain advantages, namely:
(1) The learned representations are not task-specific, which allows reusability and gives flexibility for experimentation.
(2) Being an unsupervised method, Node2Vec does not require any labeling of the training data so can be pipelined with the previous steps.
(3) The Node2Vec method provides high-level of parallelism and updates to the network can be incremental, key factors for high scalability.

This representation learning task can be applied synchronously or asynchronously after the graph updates, and the resulting graph updated with the learned representations is used to predict potential churns, as described with reference to operation 350 of process 300, described in further detail below.

Returning to FIG. 3, the process 300 uses at 350 a trained churn model to estimate a user churn probability for the user. In some embodiments, the process 300 uses the trained churn model to estimate an aggregate churn probability for all users associated with a customer. In some embodiments the customer node and/or the user nodes are updated with a label that indicates their corresponding churn probabilities. The process 300 then ends.

In some embodiments, the churn model is trained using the graph data structure, updated with the corresponding sentiment nodes, as well as the learned vector representations of the graph. In some embodiments, the churn model has multiple convolution neural networks that are arranged in series. The churn model may be trained in some embodiments whenever a predetermined amount or type of data (e.g., new customer nodes, new user input, etc.) has been added to the graph model 415, after a predetermined period of time, or according to other criteria so that the churn model remains up to date.

In some embodiments, the process 300 performs the churn probability estimation using the graph structures and vector representations learned in previous steps as input features to multiple graph convolution networks (GCNs). The GCNs perform the classification by aggregating the features of each node and its neighbors and passing them through multiple neural network layers to reduce the dimension of the representations, a process called feature smoothing.

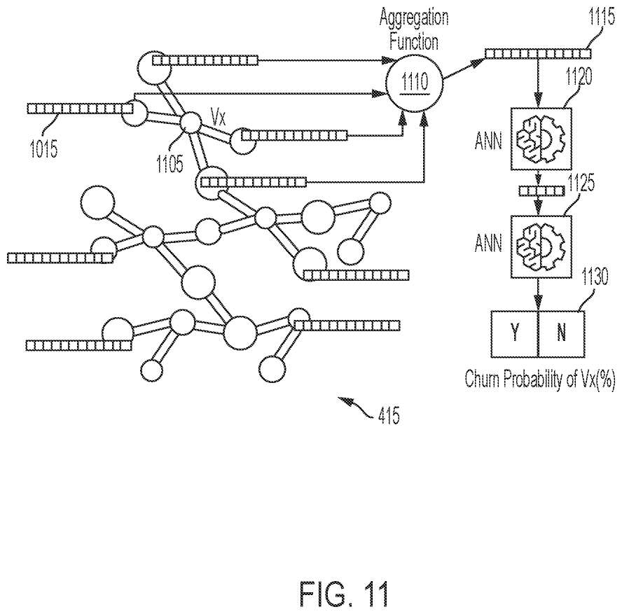

FIG. 11 illustrates churn probability estimation in some embodiments for one node 1105, here denoted as Vx, in the graph model 415. The learned vector representations 1015 from other nodes in the graph neighborhood of the Vx node 1105 are aggregated by an aggregation function 1110 into an aggregate vector representation 1115 of Vx node 1105. The aggregate vector representation 1115 of Vx node 1105 is applied to a sequence of two GCNs 1120, 1125 to produce the final prediction of the churn probability 1130. The GCN 1125 in the last layer of the neural networks reduces the dimension to the final classes of the classification problem, which in the context of churn prediction is a binary classifier stating if it is or not is a potential churn (Y or N) based on the probability of churn 1130 for the Vx node 1105.

Being a semi-supervised process, feature smoothing needs some examples of real churns. This information is added to the graph in some embodiments by labeling clients or customers that previously churned (e.g., cancelled the service) with a cancelled label.

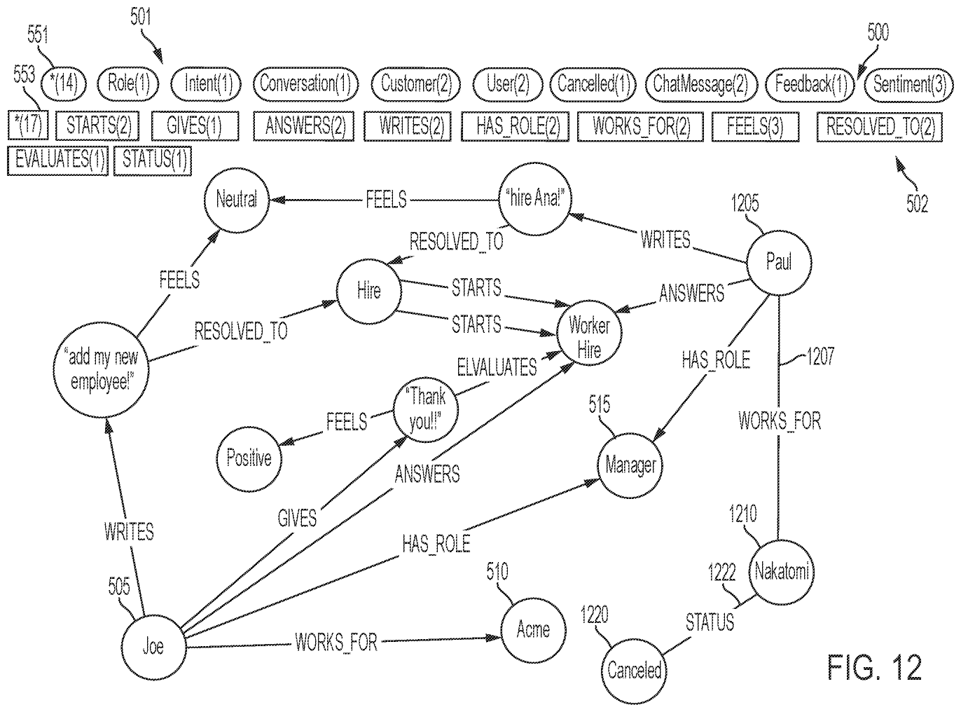

FIG. 12 shows an updated visualization 1200 of the graph data structure after updating the graph data structure with previous churns. In addition to the user node 505 for Joe and customer node 510 for Acme Company, an additional user node 1205 for Paul and a corresponding customer node 1210 for Nakatomi Corporation are shown, with an edge 1207 connecting them to indicate a WORKS_FOR relationship. Paul is also a manager for Nakatomi Corporation, as indicated by edge 1212 from user node 1205 to the role node 515 of type “Manager,” indicating a HAS_ROLE relationship. Note that in this example, this is the same role node 515 to which user node 505 is also connected, as described above with reference to FIG. 5. However, in other embodiments, different user nodes could be connected to separate role nodes, even if their roles are the same.

In this example, Nakatomi Corporation has previously churned. This is represented in the graph data structure by a canceled node 1220, which is connected to the customer node 1210 by an edge 1222 to indicate a STATUS relationship. The menu 501, edge menu 502, and their associated indicators 551, 553 may also be updated in some embodiments to reflect the additional nodes and edges associated with the second customer (Nakatomi Corporation), its employees, and user inputs. In other embodiments, the customer's status (e.g., “canceled,” “renewed,”, “new,” etc.) may be represented as a label that is applied to the customer node as metadata, instead of being represented by a separate node.

The visualizations 500, 900, 1200 of the graph data structure are optional in some embodiments. The underlying graph data structure may be manipulated, updated, etc. without visually reflecting every change.

The GCNs are applied to the graph and nodes classified with high potential of discontinuing the service are identified. In some embodiments, these identified nodes are targeted for strategic churn prevention and customer retention actions.

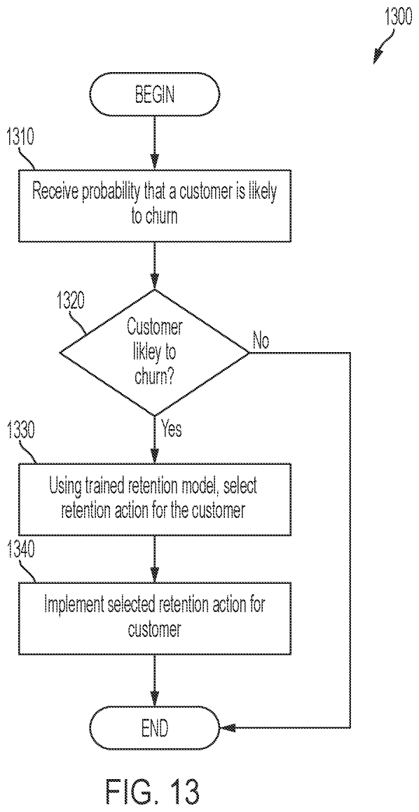

FIG. 13 shows a customer retention process 1300 performed by the HCM system of some embodiments. The process 1300 begins at 1310 by receiving a probability that a particular customer is likely to churn. For example, the process 1300 may receive the probability from operation 350 in process 300.

At 1320, the process 1300 uses the probability to make a determination whether the customer is likely to churn. If the process 1300 determines that the customer is not likely to churn, then the process 1300 ends. If the process 1300 determines that the customer is likely to churn, the process 1300 continues to 1330, which is described below.

At 1330, the process 1300 selects a retention action for the customer, using a reinforcement model that explores a plurality of retention actions, learns the optimal retention action for each context by reinforcement learning based on received rewards from successes, and exploits the optimal retention action by implementing it for target customers for the context.

In some embodiments, the reinforcement model learns, from a pre-defined set of retention actions, an optimal retention action for each context, by exploring the options (i.e., implementing the actions for customers with high probability of churn) and learning from rewards received for the cases of success. In some embodiments, the success is inferred by checking whether the customer with high probability of churn keeps using the application after being offered a retention action, e.g., after a pre-defined period of time. Selecting the retention action is also based on other customer characteristics, including the customer type (e.g., type of business, including but not limited to retail, manufacturing, food service, professional, etc.) and the customer size (e.g., number of users, employees, etc.), and this is modeled as the context. Once the model has learnt the optimal retention action (the one with the highest probability of receiving reward) for each context, it begins to exploit them, by selecting it more frequently.

In some embodiments, the reinforcement model deliberately (e.g., randomly) selects other retention actions that are not optimal. This is because there is a trade-off between exploration (random selection of retention actions, which provides no information on results) and exploitation (observing results and using those results to determine the optimal retention actions). Once result feedback from selected retention actions is received, that the reinforcement model can incorporate that knowledge (e.g., by creating or modifying policies). That knowledge is exploited but in order to anticipate temporal changes in context, some fraction of retention actions are still chosen in an exploratory manner. The ratio of exploration to exploitation retention actions is defined by the policies that define the reinforcement model. For example, in some embodiments, the exploration to exploitation ratio is 10%. The results of exploration-based retention are also used to update the policies in the model.

In some embodiments, the reinforcement model observes the results of selecting retention actions. Based on these observations, the reinforcement model learns to select the optimal action based on the context for that customer. The contextual inputs to the reinforcement model may include one or more of the probability of churn, the available retention actions, observations of the results of previous retention actions, and other environmental details. The results may include an assessment of success or failure in retaining the customer after a defined period of time (e.g., two weeks). The output of the reinforcement model is the selection of the retention action.

In some embodiments, the reinforcement model may be considered a “black box” with the above input and output. Inside the model, rules and policies define how to process the input to determine the output. These rules and policies are updated on a regular basis, and that update process is also defined by the rules of the model itself.

At 1340, the process 1300 implements the selected retention action for the customer. The process 1300 then ends. The customers (nodes of the graph) identified with high probability of discontinuing the service need to receive special care. Strategic actions that can be taken include offers of detailed help information, free product packages trials, live chat support redirection, or even discounts, all can be offered to attempt to retain these customers.

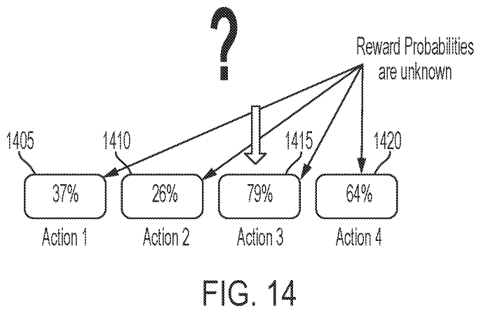

Given a set of such strategic customer retention actions to prevent losing these customers, FIG. 14 shows the problem modeled as a Multi-Armed Bandit (MAB) problem [7]. In this example, there are four retention actions 1405, 1410, 1415, and 1420. Each retention action represents a bandit with probability of reward that is initially unknown, defined as the probability of success in preventing the cancellation of the service. In FIG. 14, the actual reward probabilities are shown, to demonstrate that in actuality Actions 1415 and 1420 are the most likely to result in customer retention.

Also, in some embodiments, the unknown reward probabilities can change depending on the context. As an analogy, a given move of a chess piece (the bandit) can have different results depending on the state of the game (context). In the context of customer retention, a churn prevention action (bandit) can be more or less effective depending on the customer's industry type, market environment, years of service usage, geographic location, or size of the business in terms of revenue, number of employees, etc. (context). This is known as Contextual Bandits [8], a variation of the MAB problem.

The purpose of this step is to automatically select and offer the available options, and, based on feedback in form of rewards and the context, learn in an efficient way which action is the most successful one. For this task, any reinforcement learning technique can be adopted that solves the MAB problem. In some embodiments, the proposed solution adopts a technique called Thompson Sampling [9]. This technique is based on the idea of probability matching [10], where the actions are selected based on reward estimations. These reward estimations are sampled from distributions that are updated based on the history of rewards.

In some embodiments, multiple models may be applied for different contexts, and the output of the multiple models compared to find a consensus or majority opinion on the selected action. As an example, one model may be implemented to learn the best retention action based on customer size, another model to learn the best action based on geographic location, and a third model to learn the best option based on the revenue of the customers. Each customer may be assigned to different classifications based on their profile according to these different contexts, to provide one or more proposed actions, from which a final action can be selected.

Once the action with the best distribution is identified, it is then exploited (selected as the one to be offered more frequently than the others), but the other options continue to be explored at times. The tradeoff between exploration and exploitation is important to keep the ability to identify changes in the environment. For instance, new retention actions added as options, or changes in customer profiles can be identified and learned automatically.

It is important to notice that this ability to learn the best offer to the customer based on reward and penalty feedbacks can be applied not only to select customer churn prevention, but also for general advertisement purposes.

### REFERENCES

[1] Google BERT—https://arxiv.org/abs/1810.04805
[2] Global Vectors for Word Representation—https://nlp.stanford.edu/pubs/glove.pdf
[3] ELMo—https://allennlp.org/elmo
[4] Node2Vec—https://snap.stanford.edu/node2vec/
[5] SDNE—http://www.kdd.org/kdd2016/papers/files/rfp0191-wangAemb.pdf
[6] HOPE—https://www.kdd.org/kdd2016/papers/files/rfp0184-ouA.pdf
[7] Introduction to Multi-Armed Bandits—https://arxiv.org/pdf/1904.07272.pdf
[8] Contextual Bandits—https://en.wikipedia.org/wiki/Multi-armed_bandit#Contextual_bandit
[9] Tutorial on Thompson Sampling—https://web.stanford.edu/˜bvr/pubs/TS_Tutorial.pdf
[10] Probability matching—https://en.wikipedia.org/wiki/Probability_matching

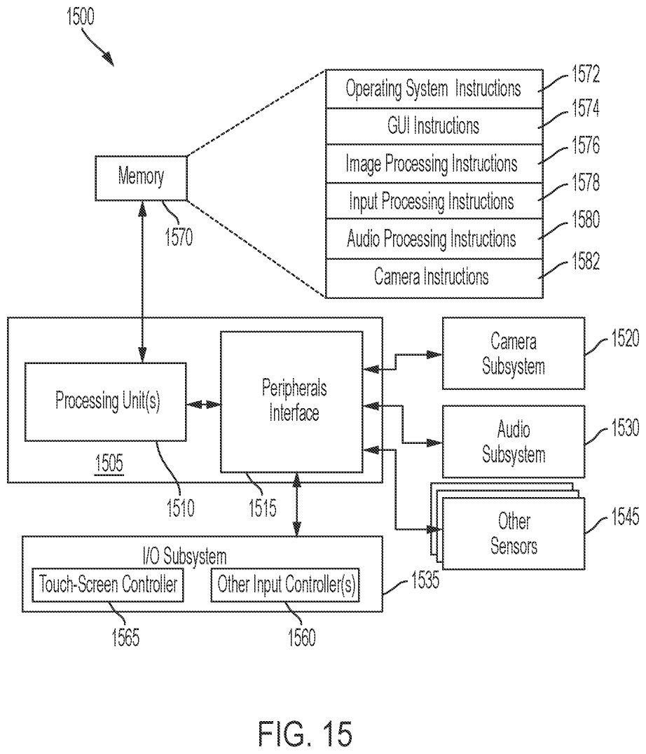

FIG. 15 is an example of an architecture of an electronic device with which some embodiments of the invention are implemented, such as a smartphone, tablet, laptop, etc., or another type of device (e.g., an IOT device, a personal home assistant). As shown, the device 1500 includes an integrated circuit 1505 with one or more general-purpose processing units 1510 and a peripherals interface 1515.

The peripherals interface 1515 is coupled to various sensors and subsystems, including a camera subsystem 1520, an audio subsystem 1530, an I/O subsystem 1535, and other sensors 1545 (e.g., motion/acceleration sensors), etc. The peripherals interface 1515 enables communication between the processing units 1510 and various peripherals. For example, an orientation sensor (e.g., a gyroscope) and an acceleration sensor (e.g., an accelerometer) can be coupled to the peripherals interface 1515 to facilitate orientation and acceleration functions. The camera subsystem 1520 is coupled to one or more optical sensors (e.g., charged coupled device (CCD) optical sensors, complementary metal-oxide-semiconductor (CMOS) optical sensors, etc.). The camera subsystem 1520 and the optical sensors facilitate camera functions, such as image and/or video data capturing.

The audio subsystem 1530 couples with a speaker to output audio (e.g., to output voice navigation instructions). Additionally, the audio subsystem 1530 is coupled to a microphone to facilitate voice-enabled functions, such as voice recognition, digital recording, etc. The I/O subsystem 1535 involves the transfer between input/output peripheral devices, such as a display, a touch screen, etc., and the data bus of the processing units 1510 through the peripherals interface 1515. The I/O subsystem 1535 various input controllers 1560 to facilitate the transfer between input/output peripheral devices and the data bus of the processing units 1510. These input controllers 1560 couple to various input/control devices, such as one or more buttons, a touch-screen, etc. The input/control devices couple to various dedicated or general controllers, such as a touch-screen controller 1565.

In some embodiments, the device includes a wireless communication subsystem (not shown in FIG. 15) to establish wireless communication functions. In some embodiments, the wireless communication subsystem includes radio frequency receivers and transmitters and/or optical receivers and transmitters. These receivers and transmitters of some embodiments are implemented to operate over one or more communication networks such as a GSM network, a Wi-Fi network, a Bluetooth network, etc.

As illustrated in FIG. 15, a memory 1570 (or set of various physical storages) stores an operating system 1572. The operating system 1572 includes instructions for handling basic system services and for performing hardware dependent tasks. The memory 1570 also stores various sets of instructions, including (1) graphical user interface instructions 1574 to facilitate graphic user interface processing; (2) image processing instructions 1576 to facilitate image-related processing and functions; (3) input processing instructions 1578 to facilitate input-related (e.g., touch input) processes and functions; (4) audio processing instructions 1580 to facilitate audio-related processes and functions; and (5) camera instructions 1582 to facilitate camera-related processes and functions. The processing units 1510 execute the instructions stored in the memory 1570 in some embodiments.

The memory 1570 may represent multiple different storages available on the device 1500. In some embodiments, the memory 1570 includes volatile memory (e.g., high-speed random access memory), non-volatile memory (e.g., flash memory), a combination of volatile and non-volatile memory, and/or any other type of memory.

The instructions described above are merely examples and the memory 1570 includes additional and/or other instructions in some embodiments. For instance, the memory for a smartphone may include phone instructions to facilitate phone-related processes and functions. An IOT device, for instance, might have fewer types of stored instructions (and fewer subsystems), to perform its specific purpose and have the ability to receive a single type of input that is evaluated with its neural network.

The above-identified instructions need not be implemented as separate software programs or modules. Various other functions of the device can be implemented in hardware and/or in software, including in one or more signal processing and/or application specific integrated circuits. For example, a neural network parameter memory stores the weight values, bias parameters, etc. for implementing one or more machine-trained networks by the integrated circuit 1505. Different clusters of cores can implement different machine-trained networks in parallel in some embodiments. In different embodiments, these neural network parameters are stored on-chip (i.e., in memory that is part of the integrated circuit 1505) or loaded onto the integrated circuit 1505 from the memory 1570 via the processing unit(s) 1510.

While the components illustrated in FIG. 15 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that the functions described with respect to FIG. 15 may be split into two or more separate components.

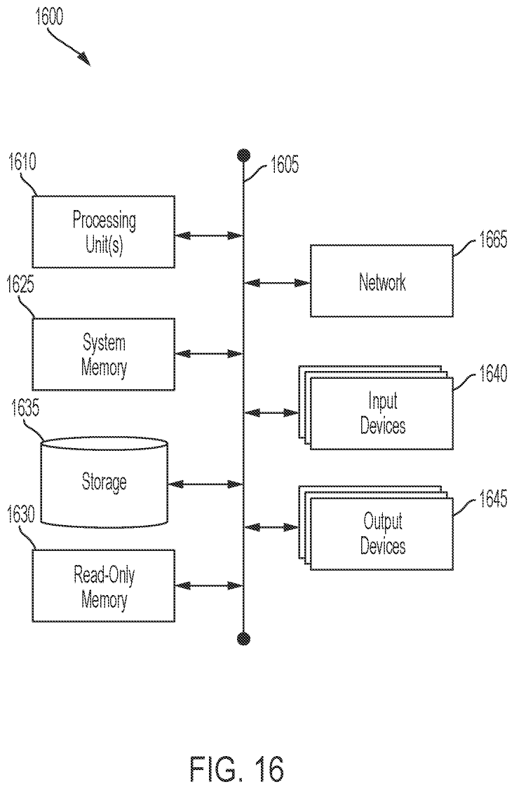

FIG. 16 conceptually illustrates an electronic system 1600 with which some embodiments of the invention are implemented. The electronic system 1600 can be used to execute any of the control and/or compiler systems described above in some embodiments. The electronic system 1600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1600 includes a bus 1605, processing unit(s) 1610, a system memory 1625, a read-only memory 1630, a permanent storage device 1635, input devices 1640, and output devices 1645.

The bus 1605 collectively represents all system, peripheral, and chipset buses that communicatively connect the numerous internal devices of the electronic system 1600. For instance, the bus 1605 communicatively connects the processing unit(s) 1610 with the read-only memory 1630, the system memory 1625, and the permanent storage device 1635.

From these various memory units, the processing unit(s) 1610 retrieves instructions to execute and data to process in order to execute the processes of the invention. The processing unit(s) may be a single processor or a multi-core processor in different embodiments.

The read-only-memory 1630 stores static data and instructions that are needed by the processing unit(s) 1610 and other modules of the electronic system. The permanent storage device 1635, on the other hand, is a read-and-write memory device. This device is a non-volatile memory unit that stores instructions and data even when the electronic system 1600 is off. Some embodiments of the invention use a mass-storage device (such as a magnetic or optical disk and its corresponding disk drive) as the permanent storage device 1635.

Other embodiments use a removable storage device (such as a floppy disk, flash drive, etc.) as the permanent storage device. Like the permanent storage device 1635, the system memory 1625 is a read-and-write memory device. However, unlike storage device 1635, the system memory is a volatile read-and-write memory, such a random-access memory. The system memory stores some of the instructions and data that the processor needs at runtime. In some embodiments, the invention's processes are stored in the system memory 1625, the permanent storage device 1635, and/or the read-only memory 1630. From these various memory units, the processing unit(s) 1610 retrieves instructions to execute and data to process in order to execute the processes of some embodiments.

The bus 1605 also connects to the input devices 1640 and output devices 1645. The input devices enable the user to communicate information and select commands to the electronic system. The input devices 1640 include alphanumeric keyboards and pointing devices (also called “cursor control devices”). The output devices 1645 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 16, bus 1605 also couples electronic system 1600 to a network 1665 through a network adapter (not shown). In this manner, the computer can be a part of a network of computers (such as a local area network (“LAN”), a wide area network (“WAN”), or an Intranet, or a network of networks, such as the Internet. Any or all components of electronic system 1600 may be used in conjunction with the invention.

As used in this specification, the terms “computer”, “server”, “processor”, and “memory” all refer to electronic or other technological devices. These terms exclude people or groups of people. As used in this specification, the terms “computer readable medium,” “computer readable media,” and “machine readable medium,” etc. are entirely restricted to tangible, physical objects that store information in a form that is readable by a computer. These terms exclude any wireless signals, wired download signals, and any other ephemeral signals.

The term “computer” is intended to have a broad meaning that may be used in computing devices such as, e.g., but not limited to, standalone or client or server devices. The computer may be, e.g., (but not limited to) a personal computer (PC) system running an operating system such as, e.g., (but not limited to) MICROSOFT® WINDOWS® available from MICROSOFT® Corporation of Redmond, Wash., U.S.A. or an Apple computer executing MAC® OS from Apple® of Cupertino, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. The computer system may include, e.g., but is not limited to, a main memory, random access memory (RAM), and a secondary memory, etc. Main memory, random access memory (RAM), and a secondary memory, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory may include, for example, (but not limited to) a hard disk drive and/or a removable storage drive, representing a floppy diskette drive, a magnetic tape drive, an optical disk drive, a read-only compact disk (CD-ROM), digital versatile discs (DVDs), flash memory (e.g., SD cards, mini-SD cards, micro-SD cards, etc.), read-only and recordable Blu-Ray® discs, etc. The removable storage drive may, e.g., but is not limited to, read from and/or write to a removable storage unit in a well-known manner. The removable storage unit, also called a program storage device or a computer program product, may represent, e.g., but is not limited to, a floppy disk, magnetic tape, optical disk, compact disk, etc. which may be read from and written to the removable storage drive. As will be appreciated, the removable storage unit may include a computer usable storage medium having stored therein computer software and/or data.

In alternative illustrative embodiments, the secondary memory may include other similar devices for allowing computer programs or other instructions to be loaded into the computer system. Such devices may include, for example, a removable storage unit and an interface. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units and interfaces, which may allow software and data to be transferred from the removable storage unit to the computer system.

Some embodiments include electronic components, such as microprocessors, storage and memory that store computer program instructions in a machine-readable or computer-readable medium (alternatively referred to as computer-readable storage media, machine-readable media, or machine-readable storage media). The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

The computer may also include an input device may include any mechanism or combination of mechanisms that may permit information to be input into the computer system from, e.g., a user. The input device may include logic configured to receive information for the computer system from, e.g., a user. Examples of the input device may include, e.g., but not limited to, a mouse, pen-based pointing device, or other pointing device such as a digitizer, a touch sensitive display device, and/or a keyboard or other data entry device (none of which are labeled). Other input devices may include, e.g., but not limited to, a biometric input device, a video source, an audio source, a microphone, a web cam, a video camera, and/or another camera. The input device may communicate with a processor either wired or wirelessly.

The computer may also include output devices which may include any mechanism or combination of mechanisms that may output information from a computer system. An output device may include logic configured to output information from the computer system. Embodiments of output device may include, e.g., but not limited to, display, and display interface, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. The computer may include input/output (I/O) devices such as, e.g., (but not limited to) communications interface, cable and communications path, etc. These devices may include, e.g., but are not limited to, a network interface card, and/or modems. The output device may communicate with processor either wired or wirelessly. A communications interface may allow software and data to be transferred between the computer system and external devices.

The term “data processor” is intended to have a broad meaning that includes one or more processors, such as, e.g., but not limited to, that are connected to a communication infrastructure (e.g., but not limited to, a communications bus, cross-over bar, interconnect, or network, etc.). The term data processor may include any type of processor, microprocessor and/or processing logic that may interpret and execute instructions, including application-specific integrated circuits (ASICs) and field-programmable gate arrays (FPGAs). The data processor may comprise a single device (e.g., for example, a single core) and/or a group of devices (e.g., multi-core). The data processor may include logic configured to execute computer-executable instructions configured to implement one or more embodiments. The instructions may reside in main memory or secondary memory. The data processor may also include multiple independent cores, such as a dual-core processor or a multi-core processor. The data processors may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

The term “data storage device” is intended to have a broad meaning that includes removable storage drive, a hard disk installed in hard disk drive, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to the computer system. It should be noted that a computer-readable medium that comprises computer-executable instructions for execution in a processor may be configured to store various embodiments of the present invention.

The term “network” is intended to include any communication network, including a local area network (“LAN”), a wide area network (“WAN”), an Intranet, or a network of networks, such as the Internet.

The term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A non-transitory computer-readable medium storing a set of instructions for predicting customer churn, which when executed by a computer, configure the computer to:
receive a graph data structure storing data associated with activity of a user, said graph data structure comprising a plurality of nodes, wherein the plurality of nodes comprise a user input node associated with the user;
update at least the user input node with a vector representation of a received user input;
using a plurality of historical user input, train a sentiment model to classify user input according to one of a plurality of sentiments;
use the trained sentiment model to classify the received user input as a particular sentiment from the plurality of sentiments;
add to the graph data structure a sentiment node that is associated with the particular sentiment and that is connected to the user input node;
using the graph data structure, train a churn model to estimate user churn probability; and
use the trained churn model to estimate a particular churn probability for the user.

2. The non-transitory computer-readable medium of claim 1, wherein the set of instructions, upon execution, further configure the computer to generate the vector representation of the received user input by using a natural language processing model to transform the received user input to the vector representation.

3. The non-transitory computer-readable medium of claim 1, wherein the set of instructions, upon execution, further configure the computer to generate the graph data structure, by extracting data from a relational database that stores a system of records associated with the activity of the user, transforming the extracted data to a database format that natively supports graph data structures, and loading the transformed data into the graph data structure.

4. The non-transitory computer-readable medium of claim 1, wherein the received user input comprises text input.

5. The non-transitory computer-readable medium of claim 1, wherein the user input node is one of a chat node, a feedback node, and a conversation node.

6. The non-transitory computer-readable medium of claim 1, wherein the plurality of sentiments comprise a positive sentiment, a neutral sentiment, and a negative sentiment.

7. The non-transitory computer-readable medium of claim 1,
the computer being further configured to use the trained churned model to estimate an aggregate churn probability for a plurality of users associated with a customer,
wherein the plurality of nodes comprise a customer node associated with the customer and a user node that is associated with the user,
wherein the user node is connected to the customer node and is connected to the user input node.

8. The non-transitory computer-readable medium of claim 7, wherein the customer is a first customer, the customer node is a first customer node, and the set of instructions, upon execution, further configure the computer to:
receive an indication that a second customer has churned, said graph data structure comprising a second customer node associated with the second customer; and
update the second customer node with a cancelled status label to indicate that the second customer has churned.

9. The non-transitory computer-readable medium of claim 7, wherein the set of instructions, upon execution, further configure the computer to update the customer node with a churn probability label that indicates the particular churn probability for the customer.

10. The non-transitory computer-readable medium of claim 1, wherein training the sentiment model comprises training a plurality of artificial neural networks that are arranged in parallel, wherein the trained sentiment model comprises the trained plurality of artificial neural networks.

11. The non-transitory computer-readable medium of claim 1, wherein the set of instructions, upon execution, further configure the computer to:
update at least the user input node with a vector representation of a neighborhood of the graph data structure, said neighborhood being associated with the user input node,
wherein the vector representation of the neighborhood of the graph data structure comprises (a) connections of the user input node to other nodes, and (b) types of nodes connected to the user input node.

12. The non-transitory computer-readable medium of claim 11, wherein the set of instructions, upon execution, further configure the computer to generate the vector representation of the neighborhood of the graph data structure by using a second-order random walk.

13. The non-transitory computer-readable medium of claim 1, wherein training the churn model comprises training a plurality of graph convolution neural networks that are arranged in series, wherein the trained churn model comprises the trained plurality of graph convolution neural networks.

14. The non-transitory computer-readable medium of claim 1, wherein the set of instructions, upon execution, further configure the computer to:
receive a plurality of observations associated with a plurality of previously applied user retentions;
use the received plurality of observations to update a reinforcement model for selecting retention actions for customers;
based on a determination that the customer is likely to churn, use the updated reinforcement model to select a particular retention action from a plurality of retention actions; and
implement the particular retention action for the customer.

15. The non-transitory computer-readable medium of claim 14, wherein the determination that the customer is likely to churn is based on at least one of a particular churn probability and the received plurality of observations.

16. The non-transitory computer-readable medium of claim 14,
wherein the reinforcement model comprises a plurality of policies,
wherein the plurality of observations comprises a plurality of successful retention actions and a plurality of failed retention actions, and
wherein updating the reinforcement model comprises updating the policies based on the plurality of successful retention actions and the plurality of failed retention actions.

17. The non-transitory computer-readable medium of claim 16, wherein updating the plurality of policies is based on a plurality of characteristics of the customer, the plurality of characteristics of the customer comprising a customer type and a customer size.

18. A non-transitory computer-readable medium storing a set of instructions for preventing customer churn, which when executed by a computer, configure the computer to:
receive a plurality of observations associated with a plurality of previously applied user retentions;
use the received plurality of observations to update a reinforcement model for selecting retention actions for customers;
based on a determination that a particular customer is likely to churn, use the updated reinforcement model to select a particular retention action from a plurality of retention actions; and
implement the particular retention action for the particular customer.

19. The non-transitory computer-readable medium of claim 18, wherein the determination that the particular customer is likely to churn is based on at least one of a probability that the particular customer is likely to churn and the received plurality of observations.

20. The non-transitory computer-readable medium of claim 18,
wherein the reinforcement model comprises a plurality of policies,
wherein the plurality of observations comprises a plurality of successful retention actions and a plurality of failed retention actions, and
wherein updating the reinforcement model comprises updating the policies based on the plurality of successful retention actions and the plurality of failed retention actions.

21. The non-transitory computer-readable medium of claim 20, wherein updating the policies is based on a plurality of customer characteristics, the plurality of customer characteristics comprising a customer type and a customer size.

22. A method for predicting customer churn, comprising:
receiving a graph data structure storing data associated with activity of a user, said graph data structure comprising a plurality of nodes, wherein the plurality of nodes comprise a user input node associated with the user;
updating at least the user input node with a vector representation of a received user input;
using a plurality of historical user input, training a sentiment model to classify user input according to one of a plurality of sentiments;
using the trained sentiment model to classify the received user input as a particular sentiment from the plurality of sentiments;
adding to the graph data structure a sentiment node that is associated with the particular sentiment and that is connected to the user input node;
using the graph data structure, training a churn model to estimate customer churn probability; and
using the trained churned model to estimate a particular churn probability for the user.

23. The method of claim 22, further comprising generating the vector representation of the received user input by using a natural language processing model to transform the received user input to the vector representation.

24. The method of claim 22, further comprising generating the graph data structure by extracting data from a relational database that stores a system of records associated with the activity of the user, transforming the extracted data to a database format that natively supports graph data structures, and loading the transformed data into the graph data structure.

25. The method of claim 22, wherein the received user input comprises text input.

26. The method of claim 22, wherein the user input node is one of a chat node, a feedback node, and a conversation node.

27. The method of claim 22, wherein the plurality of sentiments comprise a positive sentiment, a neutral sentiment, and a negative sentiment.

28. The method of claim 22, further comprising using the trained churn model to estimate an aggregate churn probability for a plurality of users associated with a customer,
wherein the plurality of nodes comprise a customer node associated with the customer and a user node that is associated with the user,
wherein the user node is connected to the customer node and is connected to the user input node.

29. The method of claim 28, wherein the customer is a first customer and the customer node is a first customer node, the method further comprising:
receiving an indication that a second customer has churned, said graph data structure comprising a second customer node associated with the second customer; and
updating the second customer node with a cancelled status label to indicate that the second customer has churned.

30. The method of claim 28, further comprising updating the customer node with a churn probability label that indicates the particular churn probability for the customer.

31. The method of claim 22, wherein training the sentiment model comprises training a plurality of artificial neural networks that are arranged in parallel, wherein the trained sentiment model comprises the trained plurality of convolution neural networks.

32. The method of claim 22, further comprising:
updating at least the user input node with a vector representation of a neighborhood of the graph data structure, said neighborhood being associated with the user input node,
wherein the vector representation of the neighborhood of the graph data structure comprises (a) connections of the user input node to other nodes, and (b) types of nodes connected to the user input node.

33. The method of claim 32, further comprising generating the vector representation of the neighborhood of the graph data structure by using a second-order random walk.

34. The method of claim 22, wherein training the churn model comprises training a plurality of graph convolution neural networks that are arranged in series, wherein the trained churn model comprises the trained plurality of graph convolution neural networks.

35. The method of claim 22, further comprising:
receiving a plurality of observations associated with a plurality of previously applied user retentions;
using the received plurality of observations to update a reinforcement model for selecting retention actions for customers;
based on a determination that the customer is likely to churn, using the updated reinforcement model to select a particular retention action from a plurality of retention actions; and
implementing the particular retention action for the customer.

36. The method of claim 35, wherein the determination that the customer is likely to churn is based on at least one of a particular churn probability and the received plurality of observations.

37. The method of claim 35,
wherein the reinforcement model comprises a plurality of policies,
wherein the plurality of observations comprises a plurality of successful retention actions and a plurality of failed retention actions, and
wherein updating the reinforcement model comprises updating the policies based on the plurality of successful retention actions and the plurality of failed retention actions.

38. The method of claim 37, wherein updating the plurality of policies is based on a plurality of characteristics of the customer, the plurality of characteristics of the customer comprising a customer type and a customer size.

39. A method for preventing customer churn, comprising:
receiving a plurality of observations associated with a plurality of previously applied user retentions;
using the received plurality of observations to update a reinforcement model for selecting retention actions for customers;
based on a determination that a particular customer is likely to churn, using the updated reinforcement model to select a particular retention action from a plurality of retention actions; and
implementing the particular retention action for the particular customer.

40. The method of claim 39, wherein the determination that the particular customer is likely to churn is based on at least one of a probability that the particular customer is likely to churn and the received plurality of observations.

41. The method of claim 39,
wherein the reinforcement model comprises a plurality of policies,
wherein the plurality of observations comprises a plurality of successful retention actions and a plurality of failed retention actions, and
wherein updating the reinforcement model comprises updating the policies based on the plurality of successful retention actions and the plurality of failed retention actions.

42. The method of claim 41, wherein updating the policies is based on a plurality of customer characteristics, the plurality of customer characteristics comprising a customer type and a customer size.
